(19) United States
(12) Patent Application Publication
(10) Pub. No.: US 2004/0088224 A1
(43) Pub. Date: May 6, 2004

(54) Method and system for delivering commodities

(75) Inventor: Syunichi Mukai, Fujisawa-shi (JP)

Correspondence Address: IBM Corporation, Intellectual Property Law Dept., 9CCA/B002, P.O. Box 12195, Res. Tri. Park, NC, 27709, US

(73) Assignee: International Business Machines Corporation, Armonk, NY

(21) Appl. No.: 10/284,783

(22) Filed: Oct. 31, 2002

(51) Int. Cl. G06F 17/60

(52) U.S. Cl. 705/26

(57) ABSTRACT

Consumers request a delivery company to regularly deliver commodities at predetermined intervals by utilizing the Internet. The consumers can appropriately change the delivery intervals by utilizing the Internet. Prices of commodities can be lowered by utilizing a home delivery service system and limiting delivery units. The consumers can purchase an appropriate quantity of commodities that matches with their amount of consumption by adjusting the delivery intervals.

### BACKGROUND OF THE INVENTION

1. Field of the Invention

The present invention relates, in general, to a method for delivering commodities consumed in daily life and/or commercial activities. For example, the invention generally relates to a method for efficiently delivering commodities, such as food and printing paper, that are consumed in home and office settings at low cost. The invention further relates to a system for implementing the above commodity delivery method.

2. Description of Related Art

Some commodities such as toilet paper and drinking water are consumed every day. These types of commodities are generally purchased in bulk, sometimes on a holiday, or at other times when the consumer or office manager becomes aware of the need to purchase them. Such purchasing efforts often require labor to bring the purchased commodity home or transport by an employee to the office, and, as a result, inconveniences in time and sometimes cost are experienced. Further, as is often the situation, despite the commitment to purchase an item, a purchaser may often encounter that a particular commodity is out of stock or unavailable when it is actually urgently needed by the purchaser. Additionally, consumers may also encounter problems from having made large quantity or bulk-based purchases, in that the consuming purchaser now needs to stock and/or store the purchased items. As becomes apparent from this situation, certain bulk-item purchases such as those involving food items or items having expiration dates, may perish or expire during long-term storage.

One method of solving these problems is to have a dealer (such as a vendor, retailer, supplier or similar) regularly deliver necessary or pre-selected commodities to a designated location (such as a home, office or similar). For example, a consumer may ask a neighboring store salesman to visit the home once or twice a week, provide the salesman an order for rice, beverages, etc., and further request that the items be delivered to the home, or that the items be delivered when the consumer calls directly.

According to these methods, however, a service area is limited, and the service is typically not offered at low cost. These methods do not lead to cost-competitive business for the stores or dealers.

Recently, general consumers have come to purchase cereals such as rice, pasta as the secondary products of the cereals, beverages and drinks, toilet paper, or other commodities at so-called “discount stores” that accomplish low cost sales through large quantity buying-in, and individual delivery of commodities from private shops described above remains underutilized. This situation may result from consumers evaluating the benefits of low prices of commodities to the inconvenience described above (inconvenience resulting from bulk purchase or inconvenience that the consumers have to go shopping frequently by themselves).

On the other hand, there is a system in which a consumer places an order through the Internet or a telephone and receives food, etc. by parcel post or home delivery service. There is another system in which a consumer makes a contract with a company to have food, etc. regularly delivered to consumer's home.

However, even these latter business systems do not offer commodities to consumers at lower prices. This is typically because the company must bear the cost of sorting commodities for each consumer as well as the cost of delivery. Since these businesses do have costs commensurate their value-added, the prices of commodities become rather high as these business costs are absorbed into the overall cost to the consumer, and many consumers may avoid these businesses as these consumers may find the additional costs not worth the benefit. Due to such high costs and limited users or consumers, these businesses are typically difficult to turn into profitable entities.

### SUMMARY OF THE INVENTION

Accordingly, there is a need for an invention that overcomes the problems discussed above. The present invention aims at providing a method for delivering commodities that eliminates requiring consumer to directly purchasing commodities at stores, enables the consumers to purchase commodities efficiently both at lower prices and according to the consumer's pace of consumption, and provides a dealer with a higher profit. The invention also aims at providing a system for implementing the method for delivering commodities.

The present invention provides a method for delivering commodities comprising the steps of receiving, for a commodity consumed constantly, a delivery unit selected by a consumer among a plurality of predetermined delivery units, and a delivery interval specified by said consumer, directing regular delivery of the commodity to said customer according to said selected delivery unit and said delivery interval, receiving a delivery interval changed by said consumer, and directing regular delivery of said commodity to said consumer according to said changed delivery interval.

In the invention, a delivery side determines in advance delivery units of commodities handled, so that physical distribution and delivery costs can be reduced. Therefore, a consumer can purchase a commodity at a lower price due to reduction of the physical distribution and delivery costs. The consumer can only select delivery of the commodity in the predetermined delivery unit but can freely select a delivery interval. Moreover, the consumer can freely adjust later the delivery interval once selected. Therefore, the consumer can regularly purchase the commodity according to his/her consumption pattern.

In the present invention described above, the method may further include the step of transmitting a Web page urging the consumer to input the changed delivery interval to the consumer. It is preferable for the consumer to change the delivery interval on the Web page as the consumer can easily adjust the delivery interval for the commodity. This is also preferable for the commodity delivery side because the troublesome operation of inputting and correcting data can be reduced.

In the present invention described above, the method may further include the steps of receiving a changed delivery unit selected from a plurality of delivery units and changed by the consumer, and directing regular delivery of the commodity to the consumer according to the changed delivery unit. The consumer can purchase the commodity in a pattern closer to his/her own consumption pattern by appropriately changing the delivery unit and combining it with the delivery interval.

In the invention described above, the commodity delivery direction is preferably given to a home delivery service company providing an any-to-any goods delivery service. The commodity delivery method of the invention may be practiced by utilizing delivery vans for home delivery service moving around in assigned areas daily, to thereby reduce the commodity delivery cost. The commodity delivery method of the invention may also be practiced by utilizing a physical distribution system for the home delivery service, to thereby reduce the physical distribution cost of commodities.

The invention described above may further include the step of transmitting to the consumer a Web page urging the consumer to input or select a kind of the commodity, delivery unit, delivery interval and delivery start date.

The Web page described above may include a calendar indicating the delivery interval of the commodity selected by the consumer. When the calendar indicating the delivery interval is displayed, the consumer can visually grasp a commodity purchase plan. This calendar is also used to select a suitable purchase interval when the consumer changes the purchase interval of the commodity.

The invention can also be grasped as a system for delivering commodities, which is provided with means for executing each step of the method described above.

As used herein, in the present invention, “commodities consumed constantly” means those which are consumed in daily life of people and in routine works in offices. Examples of the commodities consumed in ordinary home include but are not limited to toilet paper, drinking water, beverages, soft drinks, drugs, nutrients, cosmetics, toiletry such as shampoo, cereals such as rice, pasta as the secondary product of cereals, edible oil, frozen food, seasoning, soap, detergent, garbage bag, filter of water purifier, and table luxuries such as coffee. Examples of the commodities consumed constantly in offices are copying and printing paper, stationery such as writing instruments, toner and toner cartridges for copying machines, and drinking water and table luxuries consumed in offices.

As used herein, “Web page” is used to indicate world wide web based display or images on a screen that are part of a web site. The Web page may have content that when displayed, shows service contents provided by the Web site. A Web page for ordering commodities, for example, has an information input and selection function necessary for a consumer to place an order for a commodity. Inputting and selecting necessary items, the consumer can place an order for a desired commodity.

### BRIEF DESCRIPTION OF THE DRAWINGS

Other aspects, features, and advantages of the present invention will become more fully apparent from the following detailed description, the appended claims, and the accompanying drawings in which:

FIG. 1 depicts an example to which the commodity delivery method according to a preferred embodiment of the present invention can be applied;

FIG. 2 is a flowchart showing the commodity delivery method according to according to a preferred embodiment of the present invention;

FIG. 3 depicts an example of a screen of a Web page that is utilized in the commodity delivery method according to according to a preferred embodiment of the present invention; and,

FIG. 4 depicts another example to which the commodity delivery method according to according to a preferred embodiment of the present invention may be used.

### DETAILED DESCRIPTION

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings. Embodiments of the present invention will now be described in detail with reference to the accompanying drawings.

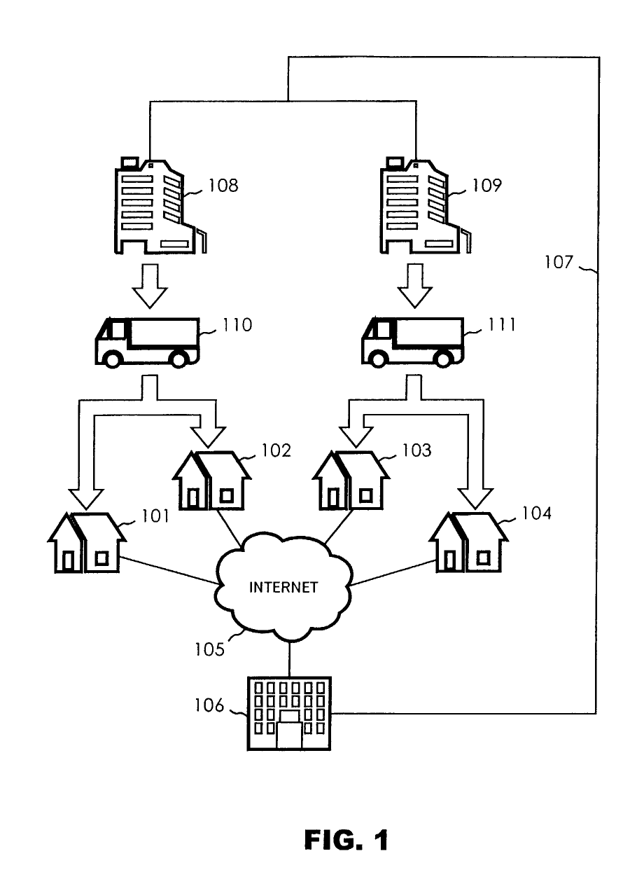

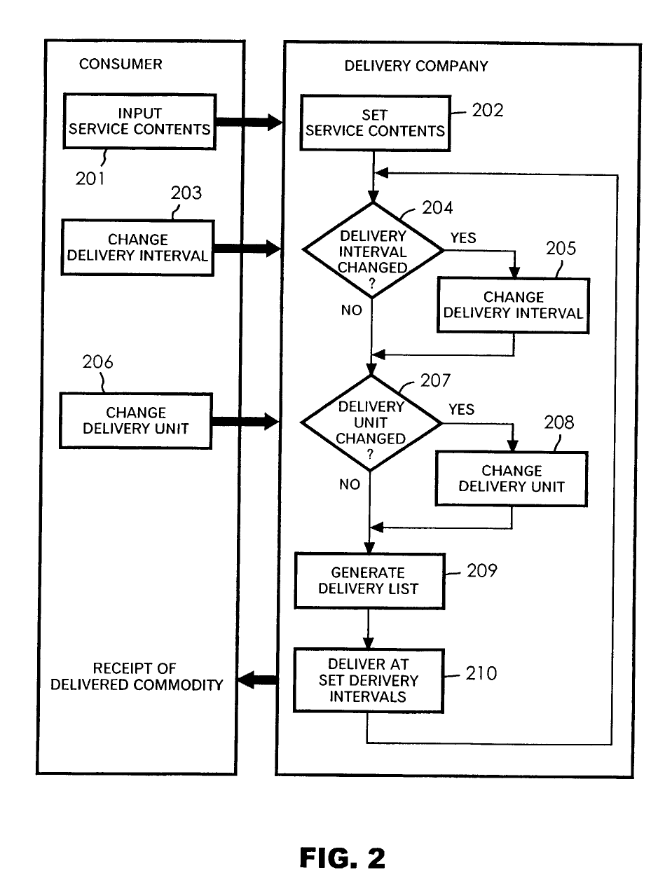

FIG. 1 depicts an example to which the commodity delivery method according to a preferred embodiment of the present invention can be applied. FIG. 2 is a flowchart showing the commodity delivery method according to according to a preferred embodiment of the present invention. In this embodiment, daily necessaries consumed in daily life are delivered to individual consumers.

In this embodiment, a system for delivering ordinary home-delivered goods to make regular delivery of commodities according to the invention capable of changing the delivery interval is provided. As used herein, “ordinary home-delivered goods” represents those goods that are delivered from any sender to any recipient through a delivery company. Generally, a delivery company called “home delivery service company” delivers presents or goods from one individual to another, and these goods are the ordinary home-delivered goods described above. The ordinary home-delivered goods are also typically used in mail order services.

FIG. 1 illustrates individual consumers 101 to 104 (represented by their houses), the Internet 105, a delivery company 106, delivery centers 108 and 109 of the delivery company, a communication line 107 connecting the delivery company 106 to the delivery centers 108 and 109, and delivery vans 110 and 111.

The individual consumers 101 to 104 can access to a Web site of the delivery company 106 through the Internet 105. Each consumer 101 to 104 inputs and selects service contents described later by utilizing the Web site of the delivery company 106.

The delivery company 106 handles the ordinary home-delivered goods described above. The delivery company 106 lets the delivery vans 110 and 111 make the rounds inside predetermined areas to conduct the daily delivery service for the home-delivered goods. In this embodiment, the delivery company 106 practices the commodity delivery method of the invention in addition to the business handling the ordinary home-delivered goods. In this embodiment, the delivery company 106 practices by itself the commodity delivery method of the invention by utilizing the home delivery system of its own.

The delivery company 106 has an Internet server (not shown) connected to the Internet 105 to practice the commodity delivery method of the invention. This Internet server provides various services described later to the consumers 101 to 104 connected thereto through the Internet 105. The delivery company 106 arranges the delivery centers 108 and 109 in appropriate areas, respectively.

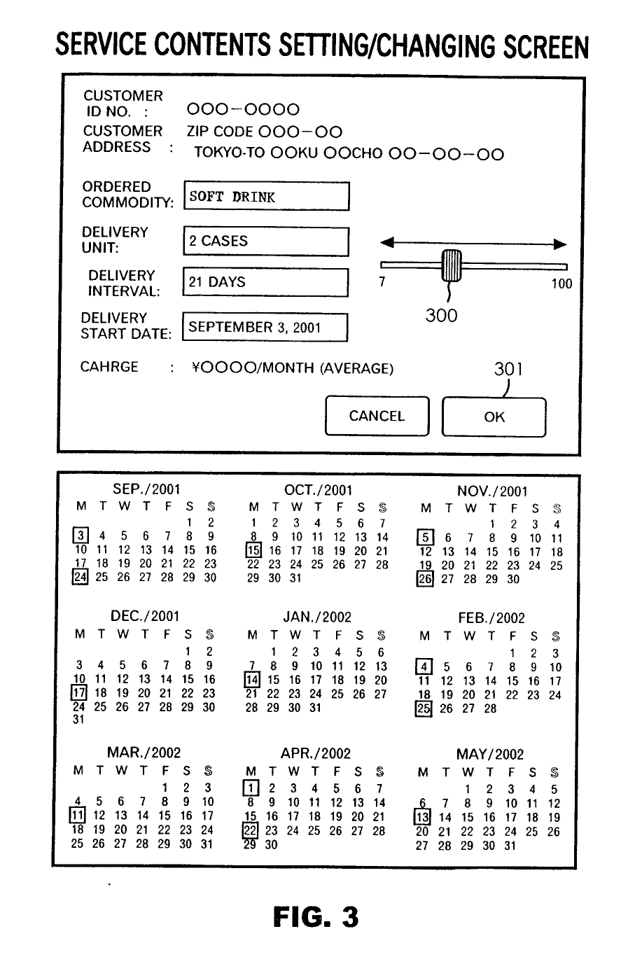

FIG. 3 shows an exemplary Web page of the Web site that the delivery company 106 opens to public on the Internet 105. The Internet server that the delivery company 105 owns is utilized to open this Web site. The Internet server has a function of transmitting various Web pages described later to the consumers 101 to 104 and a function of processing information that the consumers 101 to 104 input or select on the Web pages.

The consumers 101 to 104 can access at any time to the Web site shown in FIG. 3 through the Internet using their personal computers. On the screen of the Web page shown in FIG. 3, the consumers 101 to 104 can select or input a kind of a commodity, commodity delivery unit, commodity delivery interval and commodity delivery start date. On the screen of the Web page shown in FIG. 3, the consumers 101 to 104 can change the delivery interval as well as the delivery unit. Also, on the screen of the Web page shown in FIG. 3, the consumers can confirm a delivery schedule of the commodity presented in a calendar form.

The Web site managed by the server of the delivery company 106 includes Web pages for consumer registration, ID input, list of commodities handled, explanation of service contents, and so forth in addition to the Web page shown in FIG. 3.

An exemplar is provided herein where the consumers 101 to 104 regularly purchase commodities. For the purposes of this exemplar, it is assumed here that the consumer 101 purchases a soft drink commodity.

First, the consumer 101 establishes connection to the Web site of the delivery company 106, calls a consumer registration Web page (not shown), and conducts consumer registration. In this consumer registration, the consumer 101 inputs necessary data such as his/her own name, address, telephone number, emergency contact address, bank account number or credit card number for direct debit, and other necessary items. A charge payment method is decided at this time. After this consumer registration, an ID number is issued to the consumer 101.

On the Web site described above, the consumer 101 then calls an ID input Web page (not shown), and inputs the issued ID number. Then, the Internet server of the delivery company 106 transmits the screen of the Web page shown in FIG. 3 to a personal computer (not shown) of the consumer 101 where the screen is displayed. The consumer 101 inputs and selects the service contents that he/she receives on this screen (step 201).

The consumer 101 inputs and selects a commodity to be ordered, delivery unit, delivery interval and delivery start date on the screen shown in FIG. 3. The consumer may select the commodity from a catalog separately prepared or from a list of commodities displayed on another screen. Possible delivery units are determined in advance, which are easy-to deliver units, for example, in cases for soft drinks (24 cans for each case), in 24 rolls for toilet paper, and in 1,000 sheets for printing paper. For the canned soft drink, for example, possible delivery units are one case, two cases, three cases, . . . , N cases. The upper limit “N” is preferably determined in advance considering the efficiency of delivery. The consumer 101 selects a desired delivery unit (2 cases of canned soft drink in this example) from a plurality of delivery units determined in advance. Similar selection is done for other commodities.

The consumer 101 can arbitrarily specify the delivery interval. In the example shown in FIG. 3, the consumer can select the interval from 7 to 100 days. In the example shown in FIG. 3, the delivery interval can be arbitrarily specified in days from 7 to 100 days by moving a slider 300.

A date specified as the delivery start date should be after the passage of a predetermined period (7 days later, for example) from the day on which the consumer inputs information on the screen shown in FIG. 3. This allows the delivery company 106 to secure a necessary time for stocking and arrangements to deliver the commodity.

When the consumer specifies the delivery interval and delivery start date on the screen shown in FIG. 3, a delivery schedule calendar is displayed at a lower part of the screen. That is, the Internet server of the delivery company 106 transmits the calendar illustrating the delivery schedule to the personal computer of the consumer 101.

In the calendar, each delivery date is indicated by a rectangle surrounding that date. The calendar indicates a delivery schedule for coming nine months so that the consumer can know at a look on which day of which month the ordered commodity is to be delivered. The screen in FIG. 3 also shows an amount of charge per month on average. This monthly average charge is obtained by dividing the total charge for the commodity delivered for a year according to the schedule on the calendar by twelve.

If no problem exists for all the items in FIG. 3, the consumer 101 clicks an OK button 301 in FIG. 3 to finish inputting the service contents (step 201) and setting the service contents (step 202).

The consumer 101 can view the screen shown in FIG. 3 at any time by inputting the issued ID at the Web site of the delivery company 101. That is, the Internet server of the delivery company 106 transmits the Web page shown in FIG. 3 to the personal computer of the consumer 101 whenever the consumer 101 desires.

To change the delivery interval, the consumer 101 executes a changing process for the delivery interval on the screen shown in FIG. 3 (step 203). When this step 203 is executed, the Internet server of the delivery company 106 receives the changed delivery interval, so that judgment in step 204 executed on the side of the delivery company 106 is true. As a result, a delivery interval changing process (step 205) is executed. This step 205 rewrites the data of the delivery interval recorded in a storage device of the computer or the Internet server utilized by the delivery company 106 to the newly changed data. Steps 204 and 205 are executed by the computer or the Internet server that the delivery company 106 owns.

To change the delivery unit, the consumer 101 invokes the screen shown in FIG. 3 and executes a changing process for the delivery unit on the screen shown in FIG. 3 (step 206). When the consumer 101 changes the delivery unit, the delivery company 106 receives the changed delivery unit, so that judgment in step 207 on the side of the delivery company 106 is true. Then, the delivery company 106 executes a delivery unit changing process (step 208). Steps 207 and 208 are executed by the computer or the Internet server that the delivery company 106 owns.

In this embodiment, changes of the delivery interval and the delivery unit must be made at least seven days before the next delivery schedule date. This is to minimize influences on planned stocking of commodities and stock management performed by the delivery company 106, so that a rise in costs resulting from the change of delivering conditions is limited.

When the delivery interval changing process (step 203) and the delivery unit changing process (step 206) on the side of the consumer 101 are not executed, steps 205 and 208 are not executed on the side of the delivery company 106.

The delivery company makes out a demand estimation list for the commodity (a soft drink, in this case), and conducts stocking of the commodity and stock management according to this list. The commodities are managed in the delivery centers 108 and 109 or in a warehouse (not shown).

The delivery company 106 also makes out a delivery list describing the commodity to be delivered on a specific day from each of the delivery centers 108 and 109, and its delivery address (step 209). For example, the delivery company 106 makes out a delivery list describing the commodity to be delivered next day and its delivery address. The delivery list is sent to the delivery centers 108 and 109 through the communication line 107. This distribution of the delivery list directs commodity delivery. These operations are performed by the server or the computer that the delivery company owns.

The delivery centers 108 and 109 assort the commodities according to the delivery list sent through the communication line 107, loads the commodities to be delivered on that day to the delivery vans 110 and 111, and deliver the commodities. Here, the delivery van 110 delivers two cases of canned soft drinks to the consumer 101. This delivery is carried out according to the schedule on the calendar shown in FIG. 3 (step 210).

Unless the consumer 101 requests to change the delivery interval and/or delivery unit, step 209 makes out the list under the condition initially set in step 202, and delivery is performed according to the set delivery interval and delivery unit (step 210).

If the consumer 101 has requested to change the delivery interval and/or delivery unit, delivery in the changed delivery interval and/or delivery unit is directed and performed.

In this way, the delivery van 110 delivers the commodity to the consumer 101 according to the interval specified by the consumer 101 and according to the delivery unit selected by the consumer 101. In this example, unless the delivery interval and delivery unit have not been changed, two cases of canned soft drinks are delivered once per three weeks to the consumer 101.

In this embodiment, the consumer 101 can arbitrarily or selectively change the delivery interval in days from 7 through 100 days. In the case of soft drinks, for example, the amount of consumption may vary in a hot summer season and a cold winter season. In such a case, the consumer 101 first accesses to the Web site of the delivery company 106 through the Internet 105 and displays the Web page shown in FIG. 3 on the personal computer of its own. Next, the consumer 101 changes the delivery interval on the screen. When the consumption of soft drink drops in winter, for example, the consumer 101 may extend the delivery interval to 40 days.

The consumer 101 may also change the delivery unit of the commodity on the screen shown in FIG. 3. Selecting a suitable combination of the delivery interval and the delivery unit of the commodity, the consumer 101 can purchase the commodity according to his/her own consumption style. Since this embodiment aims at cost reduction, the consumer 101 cannot finely select the delivery unit, but can instead change finely the delivery interval of the commodity regularly delivered, so that the consumer can purchase the commodity according to his/her own consumption.

The consumer 101 can visually grasp the delivery interval by viewing the calendar on the screen shown in FIG. 3. Therefore, the consumer can suitably set the delivery interval. This advantage also holds true in the change of the delivery unit.

Since this embodiment limits the delivery units to those which the delivery company 106 can easily handle, the embodiment can limit the cost of commodity delivery to the consumers and the physical distribution cost of commodities. This cost reduction can achieve lower prices of commodities. Also, while the consumer cannot finely specify the delivery quantity since the delivery units are determined in advance, the consumer can arbitrarily specify the delivery interval and can arbitrarily change it, so that delivery according to the consumption pattern of the consumer can be accomplished. Thus, the consumer can efficiently purchase more economical commodities.

In this embodiment, the delivery company delivers commodities to the entrance of the house of each consumer. Therefore, the trouble of carrying heavy commodities from the store can be eliminated. Also, since the commodities are regularly delivered, the problems of damage and deterioration of commodities, and securing a storage place thereof can be relieved.

The operations of assorting commodities and loading them to the delivery vans 110 and 111 at the delivery centers 108 and 109, and the delivery work by the delivery vans 110 and 111 in the assigned areas are daily routines of the delivery company conducting the ordinary home delivery service. Therefore, no drastic increase occurs in the cost even when the delivery method of the invention is additionally carried out. The delivery company 106 can utilize the existing physical distribution system for the home delivery service in the delivery method of the invention to reduce the delivery cost. The regular delivery operations for commodities in which the delivery interval can be changed according to this embodiment can be accomplished by utilizing the existing home delivery system without considerably increasing the cost.

Further, since the delivery company 106 can obtain the latest update information through the Internet, troublesome data inputting operations can be reduced, and stocking plans, stocking operations and inventory management for commodities can be efficiently conducted.

Also, since commodities are regularly delivered over a long time, the delivery company 106 can easily estimate consumption of commodities handled and can efficiently conduct stocking and inventory management. Additionally, since the delivery company 106 can stock commodities in bulk, the stocking cost can be reduced. Thus, unit prices of commodities to be purchased by consumers can be reduced.

Although the stocking and inventory management of the delivery company 106 may be affected by the changes of delivery intervals and delivery units by the consumers, it is expected that the total quantity per day is statistically standardized and may approach to a constant value if the number of consumers increases and the delivery intervals are specified at random, which leads to steady stocking and delivery charge, so that the stocking/delivery cost is expected to become lower.

It has been a common practice to have the delivery vans 110 and 111 visit the assigned areas even when only one commodity (ordinary home-delivered goods) is to be delivered. The delivery vans 110 and 111 have also to visit small agencies. For these reasons, utilization efficiency of the delivery vans 110 and 111 has not necessarily been high. According to the system of this embodiment, however, utilization efficiency of the delivery vans can be improved since a constant quantity of commodities to be delivered can be secured regularly.

Further, since the consumers promise to purchase commodities over a long time, the delivery company can secure clients with smaller sales efforts and can get stable profit.

As described above, the consumers can regularly get delivery of economical commodities and can enjoy the merit of adjusting the amount of purchase according to their amount of consumption by changing the delivery interval. On the other hand, the delivery company can improve utilization efficiency of the delivery vans, secure customers over a long time, and get stable profit. Thus, a business profitable to both consumers and delivery company can be expanded.

While the invention has been described concretely with reference to the embodiment thereof, it is not limited to the above embodiments, and can be changed or modified without departing from the scope thereof.

While, in the above embodiment, two cases of canned soft drinks are delivered to the consumer 101, any commodity other than or in addition to soft drinks can be delivered in the same way. Delivery of commodities to other consumers can also be made in the same way.

In the above embodiment, the consumer may specify a delivery time. Selection of the delivery interval may be made in weeks or months. Further, the consumer may cancel a specific delivery date in the calendar shown in FIG. 3. For example, when the consumer makes a long-term trip, delivery during the trip or delivery immediately before the trip may be canceled. Cancellation of the delivery on the specific delivery date may be conveniently made through the Web site.

The consumers who receive commodities delivered may be companies, offices, schools or other organizations in addition to individuals. For example, the invention may be applied to a system for regularly delivering drinking water and seasonings to restaurants.

While two delivery centers 108 and 109 are shown in FIG. 1, the number of delivery centers is not limited thereto. Also, the numbers of delivery vans and consumers are not limited in the invention. An organization for collectively managing a plurality of delivery centers may be provided. The communication line 107 may be a dedicated line or the Internet line.

A slip having the delivery schedule for each consumer printed thereon may be distributed to each consumer when the delivery vans deliver commodities.

A company that practices the commodity delivery method of the invention may present a calendar to the consumer representing a typical purchase pattern for each commodity in the Web site that provides the screen shown in FIG. 3. The consumer can make a purchase plan of a commodity with reference to this calendar. The calendar may take the form shown in FIG. 3, for example.

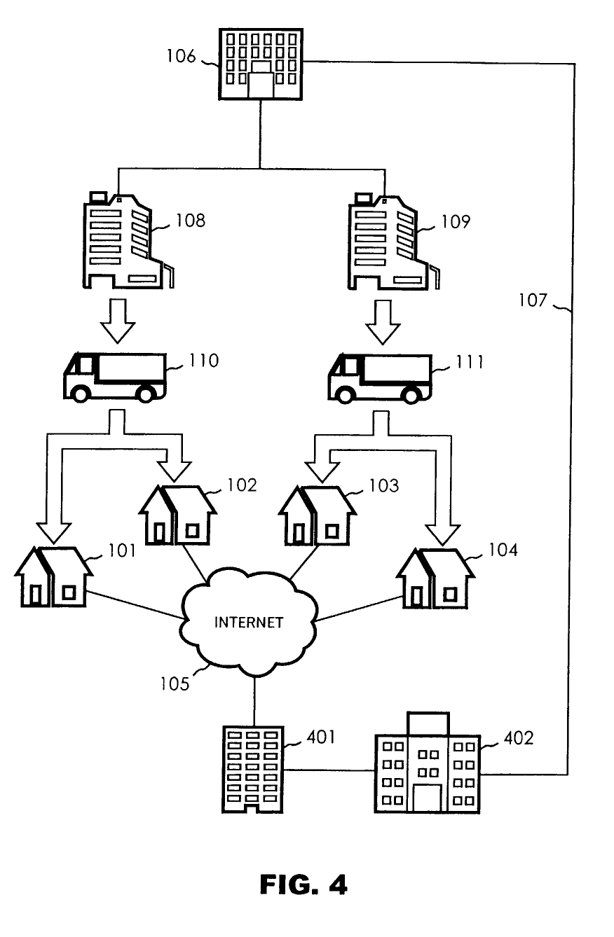

A company different from the delivery company 106 may operate the Web site for customer registration and procure commodities. FIG. 4 depicts another example to which the commodity delivery method according to according to a preferred embodiment of the present invention may be used. In the embodiment shown in FIG. 4, a company 401 that collects and processes demands from customers through the Internet 105, and controls the overall operation, a company 402 that stocks commodities (trading company, for example), and a delivery company 106 are different organizations, respectively. In the embodiment shown in FIG. 4, the companies 401 and 402 may be the same. Alternatively, the company 401 may be the one that expands the business nationwide while the companies 402 and 106 may exist for each local area.

In the system shown in FIG. 4, the company 402 handling the commodities may comprise different organizations for the respective commodities. For example, a plurality of companies such as a company handling drinking water, a company handling toilet paper and a company handling office supplies may exist, and the company 401 that collects and processes the demands from the consumers may collectively control these companies and deliver commodities to the consumers 101 to 104 by utilizing the physical distribution system of the delivery company 106.

A facility that allows the consumers to establish connection with the Internet 105 is not limited to a personal computer, and may be a mobile information processing terminal, mobile phone, or other home appliance capable of connecting with the Internet.

The company practicing the invention may give discount points to the consumers who have purchased commodities at a charge above a predetermined amount, and to the consumers who continuously keep purchasing commodities over a predetermined period or longer so as to discount the charge.

The invention can be carried out at low cost when the physical distribution system of the home delivery service is utilized. However, an independent delivery system may be utilized in the delivery method of the invention separately from the home delivery service system.

The advantages brought forth by the invention described in this application include, but are not limited to the following: the customers need not directly purchase commodities at stores, and can purchase the commodities at lower prices; the customers can efficiently purchase the commodities according to their paces of consumption; and the company can secure a greater number of customers for a long period, and can get high profit.

Additionally, the configuration described in the above-described embodiments is but exemplary. It will be further understood that various changes in the details, materials, configurations and arrangements of the parts which have been described and illustrated in order to explain the nature of this invention may be made by those skilled in the art without departing from the principle and scope of the invention as expressed in the following claims.

What is claimed is:

1. A method for delivering commodities comprising the steps of:
receiving, for a commodity to be consumed, a delivery unit selected by a consumer among a plurality of predetermined delivery units, and a delivery interval specified by said consumer; and directing regular delivery of the commodity to said customer according to said selected delivery unit and said delivery interval.

2. The method according to claim 1, further comprising the step of receiving a delivery interval changed by said consumer.

3. The method according to claim 2, further comprising the step of directing regular delivery of said commodity to said consumer according to said changed delivery interval.

4. The method according to claim 3, further comprising the step of transmitting a Web page urging said consumer to input said changed delivery interval to said consumer.

5. The method according to claim 3, further comprising the steps of:
receiving a changed delivery unit selected from said plurality of delivery units and changed by said consumer; and
directing regular delivery of said commodity to said consumer according to said changed delivery unit.

6. The method according to claim 3, wherein said delivery direction for said commodity is given to a home delivery service company providing an any-to-any goods delivery service.

7. The method according to claim 3, further comprising the step of transmitting a Web page presenting a schedule of delivery of said commodity to said consumer.

8. The method according to claim 3, further comprising the step of transmitting to said consumer a Web page urging said consumer to input or select a type of said commodity, delivery unit, delivery interval and delivery start date.

9. The method according to claim 8, wherein said Web page includes a calendar indicating the delivery interval of the commodity selected by said consumer.

10. A system for delivering commodities comprising:
means for receiving, for a commodity consumed constantly, a delivery unit selected by a consumer among a plurality of predetermined delivery units, and a delivery interval specified by said consumer;
means for directing regular delivery of the commodity to said consumer according to said selected delivery unit and said delivery interval.

11. The system according to claim 10, further comprising means for receiving a delivery interval changed by said consumer.

12. The system according to claim 11, further comprising means for directing regular delivery of said commodity to said consumer according to said changed delivery interval.

13. The system according to claim 12, further comprising means for transmitting a Web page urging said consumer to input said changed delivery interval to said consumer.

14. The system according to claim 12, further comprising:
means for receiving a changed delivery unit selected from said plurality of delivery units and changed by said consumer; and
means for directing regular delivery of said commodity to said consumer according to said changed delivery unit.

15. The system according to claim 12, wherein said delivery direction for said commodity is given to a home delivery service company providing an any-to-any goods delivery service.

16. The system according to claim 12, further comprising means for transmitting a Web page presenting a schedule of delivery of said commodity to said consumer.

17. The system according to claim 12, further comprising means for transmitting to said consumer a Web page urging said consumer to input or select a kind of said commodity, delivery unit, delivery interval and delivery start date.

18. The system according to claim 17, wherein said Web page includes a calendar indicating the delivery interval of the commodity selected by said consumer.
